(19) United States
(12) Patent Application Publication
(10) Pub. No.: US 2026/0116107 A1
(43) Pub. Date: Apr. 30, 2026

(54) LIQUID EJECTION HEAD UNIT AND PROTECTIVE CASE

(71) Applicant: CANON KABUSHIKI KAISHA, Tokyo (JP)

(72) Inventors: SHOGO KAWAMURA, Kanagawa (JP); TAKUYA IWANO, Tokyo (JP); KOJI TACHIBANA, Kanagawa (JP)

(21) Appl. No.: 19/371,804

(22) Filed: Oct. 28, 2025

(30) Foreign Application Priority Data
Oct. 29, 2024 (JP) 2024-189808

(51) Int. Cl. B41J 29/13

(52) U.S. Cl. CPC B41J 29/13

(57) ABSTRACT

A liquid ejection head has a reference portion protruding in a first direction from a first end surface facing one side in the first direction, a protective case has a case main body having a containing portion for the liquid ejection head, an opening portion that opens the containing portion such that the liquid ejection head is inserted, and an engaged portion as well as a lid having an engagement portion capable of being engaged with the engaged portion and configured to close the opening portion, the containing portion has a recessed portion recessed in the first direction and extending in a second direction so as to guide the reference portion when the liquid ejection head is inserted into the containing portion, and the engaged portion and the recessed portion have a region where the engaged portion and the recessed portion overlap each other.

### BACKGROUND

### Field of the Technology

The present disclosure relates to a protective case for protecting a liquid ejection head to be used in a liquid ejection apparatus for ejecting liquid, such as ink, when the liquid ejection head is not in use and to a liquid ejection head unit as a form of protection of the liquid ejection head by such a protective case.

### Description of the Related Art

In a liquid ejection apparatus such as an ink jet printer, a liquid ejection head may be configured to be manufactured separately from an apparatus main body, and packaged and distributed in a state where the liquid ejection head is not attached to the apparatus main body, and then attached to the apparatus main body by a user or the like at the time of use. A protection form (transportation form or distribution form) of an unused (new) liquid ejection head is disclosed in Japanese Patent Application Publication No. 2002-321387. That is, a protective cap is attached to a face surface (liquid ejection surface) of the liquid ejection head, and the liquid ejection head is contained in a resin-molded tray serving as a protective case and sealed in an aluminum bag to be conveyed. This allows the liquid ejection head before being attached to the apparatus main body to be protected from impact such as drop or vibration during distribution.

As a protection form for the liquid ejection head, it is desirable that the protective case is configured to have a minimum size to offer an advantage particularly during distribution.

### SUMMARY

The present disclosure is directed to provide a technology that allows a size reduction of a liquid ejection head unit as a form of protection of a liquid ejection head by a protective case.

An aspect of the present disclosure provides a liquid ejection head unit comprising:
a liquid ejection head attachable to and detachable from a liquid ejection apparatus; and
a protective case capable of containing the liquid ejection head detached from the liquid ejection apparatus,
wherein the liquid ejection head has a reference portion protruding in a first direction from a first end surface facing one side in the first direction, the reference portion being used in a case where the liquid ejection head is attached to the liquid ejection apparatus,
wherein the protective case includes:
   a case main body having a containing portion that contains the liquid ejection head, an opening portion that opens the containing portion to outside such that the liquid ejection head is inserted into the containing portion in a second direction intersecting the first direction, and an engaged portion; and
   a lid having an engagement portion capable of being engaged with the engaged portion and attachable to and detachable from the case main body so as to close the opening portion,
wherein the containing portion has a recessed portion recessed in the first direction, and the recessed portion extends in the second direction so as to guide the reference portion in the second direction in a case where the liquid ejection head is inserted into the containing portion, and
wherein the engaged portion and the recessed portion have a region where the engaged portion and the recessed portion overlap each other in a case of being viewed in a third direction intersecting each of the first direction and the second direction.

In addition, an aspect of the present disclosure provides a protective case capable of containing a liquid ejection head detached from a liquid ejection apparatus, the protective case comprising:
a case main body; and a lid attachable to and detachable from the case body,
wherein the case main body includes:
   a containing portion that contains the liquid ejection head, the liquid ejection head having a reference portion protruding in a first direction to be used in a case where the liquid ejection head is attached to the liquid ejection apparatus;
   an opening portion that opens the containing portion to outside such that the liquid ejection head is inserted into the containing portion in a second direction intersecting the first direction; and
   an engaged portion,
wherein the lid has an engagement portion capable of being engaged with the engaged portion,
wherein the containing portion has a recessed portion recessed in the first direction, and the recessed portion extends in the second direction so as to guide the reference portion in the second direction in a case where the liquid ejection head is inserted into the containing portion, and
wherein the engaged portion and the recessed portion have a region where the engaged portion and the recessed portion overlap each other in a case of being viewed in a third direction intersecting each of the first direction and the second direction.

Further features of the present disclosure will become apparent from the following description of embodiments with reference to the attached drawings. The following description of embodiments is described by way of example.

### BRIEF DESCRIPTION OF THE DRAWINGS

FIG. 1A is a perspective view of a liquid ejection head in a first embodiment of the present disclosure when a lower surface (liquid ejection surface) side of the liquid ejection head is viewed obliquely from below.

FIG. 1B is a perspective view of the liquid ejection head in the first embodiment of the present disclosure when an upper surface side of the liquid ejection head is viewed obliquely from above.

FIG. 2 is an explanatory view of an example of use of the liquid ejection head according to the first embodiment of the present disclosure.

FIG. 3A is a diagram illustrating a first sidewall side in a protective case in the first embodiment of the present disclosure.

FIG. 3B is a diagram illustrating a second sidewall side in the protective case in the first embodiment of the present disclosure.

FIG. 4A is a top view of the protective case in the first embodiment of the present disclosure.

FIG. 4B is a front view of the protective case in the first embodiment of the present disclosure.

FIG. 5A is an explanatory view of the protective case in the first embodiment of the present disclosure, which is a cross-sectional view along a line A-A shown in FIG. 4A.

FIG. 5B is an enlarged view of a portion B shown in FIG. 5A.

FIG. 5C is an enlarged view of a portion C shown in FIG. 5A.

FIG. 6 is an explanatory view of the protective case in the first embodiment of the present disclosure.

FIG. 7 is an explanatory view of the protective case in the first embodiment of the present disclosure.

FIG. 8A is an explanatory view of the protective case in the first embodiment of the present disclosure, which is a perspective view of a lower surface of a lid member.

FIG. 8B is an explanatory view of the protective case in the first embodiment of the present disclosure, which is a perspective view from an upper face of a case member.

FIG. 9A is an explanatory view of the protective case in the first embodiment of the present disclosure, which is a top view of the case member.

FIG. 9B is a top view illustrating a state where the liquid ejection head is contained in the case member.

FIG. 10A is an explanatory view of attachment of the lid member of the protective case before engagement.

FIG. 10B is an explanatory view of the attachment of the lid member of the protective case during the engagement.

FIG. 11 is an explanatory view illustrating a state where the protective case is contained in a bag member.

FIG. 12A is a perspective view showing a liquid ejection head included in a liquid ejection head unit in a second embodiment of the present disclosure.

FIG. 12B is a perspective view illustrating an example of use of the liquid ejection head in the second embodiment of the present disclosure.

FIG. 13A is a perspective view of a protective case in the second embodiment of the present disclosure.

FIG. 13B is a top view of the protective case in the second embodiment of the present disclosure.

FIG. 14A is an explanatory view of the protective case in the second embodiment of the present disclosure, which is a top view of a case member.

FIG. 14B is a diagram illustrating a state where the liquid ejection head is contained in the case member.

FIG. 15A is a top view of a case member of a protective case in a third embodiment of the present disclosure.

FIG. 15B is a top view illustrating a state where a liquid ejection head is contained in the case member of the protective case in the third embodiment of the present disclosure.

### DESCRIPTION OF THE EMBODIMENTS

Referring to the drawings, modes for implementing this disclosure will be described below in detail by way of example on the basis of embodiments. However, dimensions, materials, shapes, relative positioning, and the like of components described in the embodiments are to be appropriately modified in accordance with a configuration and various conditions of an apparatus to which the disclosure is applied. In other words, the scope of this disclosure is not intended to be limited to the following embodiments.

While a plurality of features are described in the individual embodiments described below, all of the plurality of features are not necessarily essential to the disclosure, and the plurality of features may also be combined with each other in any way. Moreover, in the accompanying drawings, the same reference numerals will be assigned to the same or similar components among the individual embodiments, and repetitive descriptions will be omitted.

### First Embodiment

A liquid ejection head unit according to a first embodiment of the present disclosure is configured herein to include a liquid ejection head attachable to and detachable from an apparatus main body of a liquid ejection apparatus and a protective case capable of containing the liquid ejection head in a state detached from the apparatus main body of the liquid ejection apparatus. Typically, a form in which a new or unused liquid ejection head manufactured separately from the liquid ejection apparatus is contained in the protective case corresponds to the liquid ejection head unit according to the present embodiment. The liquid ejection head unit may also assume a packaging form in which the protective case containing the liquid ejection head is further contained in, e.g., a bag. The liquid ejection head included in the liquid ejection head unit is not limited to a new one or an unused one. For example, when the liquid ejection head attached to the liquid ejection apparatus needs to be temporarily removed from the liquid ejection apparatus (apparatus main body), there may be a conceivable case where the liquid ejection head is temporarily contained in the protective case. A storage form at this time also corresponds to the liquid ejection head unit according to the present embodiment. In this case, the liquid ejection head is a used or already attached liquid ejection head.

Examples of the liquid ejection apparatus in which the liquid ejection head is to be used include a typical recording apparatus, such as an ink jet printer, which ejects liquid such as ink onto a recording medium to form and record an image or the like using the liquid on the recording medium. In addition, apparatuses such as a copying machine, a facsimile having a communication system, and a word processor having a printing unit can also be shown as the examples. Furthermore, subject matters to which the present disclosure applies also include a liquid ejection head to be used in an industrial recording apparatus compositely combined with various processing apparatuses.

As a recording method (liquid ejection method) of the recording apparatus, a serial-scan type, a page-wide type, or the like can be mentioned. The serial-scan type is a recording method in which a recording operation is performed while a carriage is moved. The page-wide type is a method in which a liquid ejection head having a size corresponding to a width of a recording medium is used to fix a carriage and perform a recording operation while conveying only the recording medium. As compared to the serial-scan type, the page-wide type is capable of simultaneously performing multiple recordings and has a high recording speed, and is therefore adopted oftentimes in a liquid ejection recording apparatus that requires high-speed recording. Page-wide-type liquid ejection heads include one in which print chips (ejection modules) forming nozzles for ejecting ink are arranged over the entire width of a recording medium and one configured by combining a plurality of liquid ejection heads in a width direction. In the page-wide-type liquid ejection head, since an electrical connection portion, an ink supply portion, and the like are arranged on a top surface opposite to a face surface, the top surface needs be protected. In addition to a possibility of use of a configuration in which a portion for positioning with respect to the recording apparatus body projects to the outside, a casing has a height, and consequently a size of a tray tends to be increased.

The protective case included in the liquid ejection head unit according to the present embodiment is particularly preferred as a protective case for distribution which individually contains a plurality of liquid ejection heads included in the page-wide type, which allows a size reduction of the liquid ejection head unit. The protective case in the present embodiment is characterized in that a periphery of a receiving surface of each of positioning reference portions for the liquid ejection head is effectively used as a space for engaging a case main body with a lid member. According to the present embodiment, it is possible to provide the protective case which is reduced in size, while protecting a top surface of the liquid ejection head.

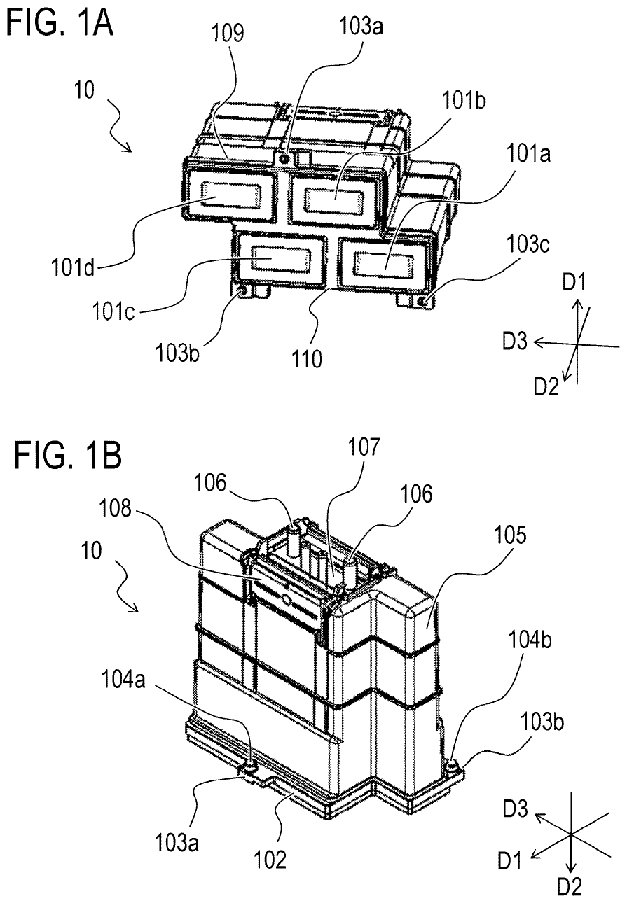

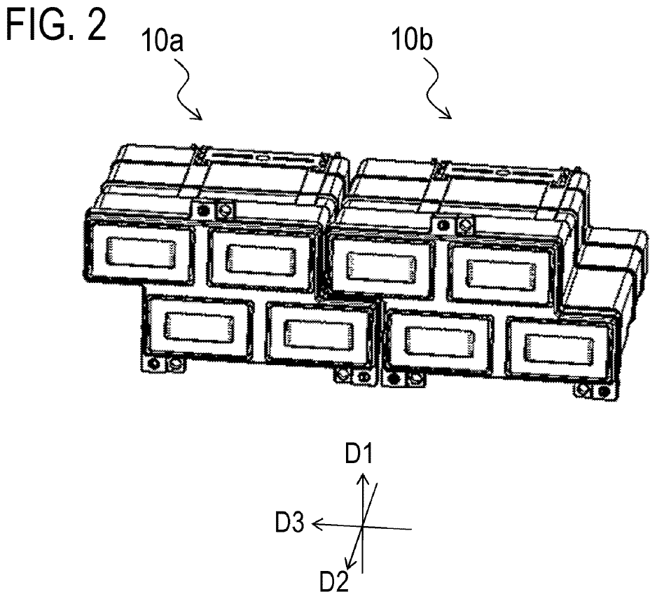

Referring to FIG. 1A, FIG. 1B, and FIG. 2, a description will be given of a configuration of a liquid ejection head 10 included in the liquid ejection head unit in the first embodiment of the present disclosure. FIG. 1A is a perspective view of the liquid ejection head 10 when a lower surface (liquid ejection surface) side of the liquid ejection head 10 is viewed obliquely from below. FIG. 1B is a perspective view of the liquid ejection head 10 when an upper surface side of the liquid ejection head 10 is viewed obliquely from above. FIG. 2 is a perspective view illustrating an example of use of the liquid ejection head 10.

As shown in FIG. 1A, in the liquid ejection head 10 in the present embodiment, recording element substrates 101a, 101b, 101c, and 101d which eject liquid are arranged in a staggered configuration. In each of the recording element substrates 101a to 101d, a plurality of liquid ejection ports (not shown) are provided to be aligned. Each of the recording element substrates 101a to 101d is disposed such that the liquid ejection ports thereof face the same direction (direction D2 (second direction)). In a position assumed by the liquid ejection head 10 attached to the apparatus main body of the liquid ejection apparatus during a liquid ejecting operation (recording operation) of the liquid ejection apparatus, a direction faced by each of the liquid ejection ports is typically downward in a vertical direction (gravity direction).

The liquid ejection surface of the liquid ejection head 10 is configured to include a set of the plurality of recording element substrates 101a to 101d. The plurality of recording element substrates 101a to 101d are arranged adjacent to each other in each of a direction D1 (first direction) and a direction D3 (third direction) intersecting the direction D2 faced by the liquid ejection ports and intersecting each other.

A staggered arrangement of the plurality of recording element substrates 101a to 101d can be described, for example, as follows. That is, as shown in FIG. 1A, the recording element substrate 101a and the recording element substrate 101b adjacent to the recording element substrate 101a in the direction D1 (first direction) are arranged offset (displaced) from each other in the direction D3. Likewise, the recording element substrate 101b and the recording element substrate 101c adjacent to the recording element substrate 101b in the direction D1 (first direction) are arranged offset from each other in the direction D3. Likewise, the recording element substrate 101c and the recording element substrate 101d adjacent to the recording element substrate 101c in the direction D1 (first direction) are arranged offset from each other in the direction D3.

Alternatively, the staggered arrangement of the plurality of recording element substrates 101a to 101d can also be described as follows. That is, the recording element substrate 101a and the recording element substrate 101c form a substrate row (first substrate row) aligned in the direction D3, and the recording element substrate 101b and the recording element substrate 101d form another substrate row (second substrate row) aligned in the direction D3. The first substrate row and the second substrate row are arranged adjacent to each other in the direction D1 and offset (displaced) from each other in the direction D3.

In addition, as shown in FIG. 2, the liquid ejection head 10 allows a page-wide-type liquid ejection head to be configured by arranging a plurality of liquid ejection heads 10a and 10b each having the same configuration in the longitudinal direction (first direction).

As shown in FIG. 1A, the liquid ejection head 10 has positioning reference portions (hereinafter referred to as reference portions) 103a, 103b, and 103c to be used at the time of attachment thereof to the liquid ejection apparatus. As shown in FIG. 2, the reference portions 103a to 103c are formed on two opposing sidewalls which do not disturb proximity arrangement of the liquid ejection heads 10a and 10b. Specifically, the liquid ejection head 10 has a base plate 102 to which the plurality of recording element substrates 101a to 101d are bonded, and the reference portions 103a to 103c are provided on sidewalls (end surfaces) of the base plate 102 facing each other in the direction D1. The reference portion 103a is formed at a center portion of a first sidewall 109 (first end surface) facing one side in the direction D1 (downstream side in a direction of an arrow) of the base plate 102 so as to protrude in the direction D1. The reference portions 103b and 103c are formed at both ends of a second sidewall 110 (second end surface) in the direction D3 which faces the first sidewall 109 of the base plate 102 so as to protrude in the direction D1. The second sidewall 110 is the sidewall of the base plate 102 facing another side in the direction D1 (upstream side in the direction of the arrow).

As shown in FIG. 1B, the reference portions 103a to 103c include, on respective upper surfaces thereof, spherical bodies 104a, 104b, and 104c (not shown) serving as positional references.

As shown in FIG. 1A, in the liquid ejection head 10 in the present embodiment, since the plurality of recording element substrates 101a to 101d are arranged in the staggered configuration, the first sidewall 109 and the second sidewall 110 of the base plate 102 are offset from each other in the direction D3.

As shown in FIG. 1B, a flow path portion, an electric substrate, and the like are contained inside a casing 105 on the base plate 102, and a top surface of the casing 105 is provided with flow path tubes 106 that supply and discharge the ink and the like. At the root of each of the flow path tubes 106, an elastic member 107 is disposed. Inside a cover 108, a connector for electric connection is contained.

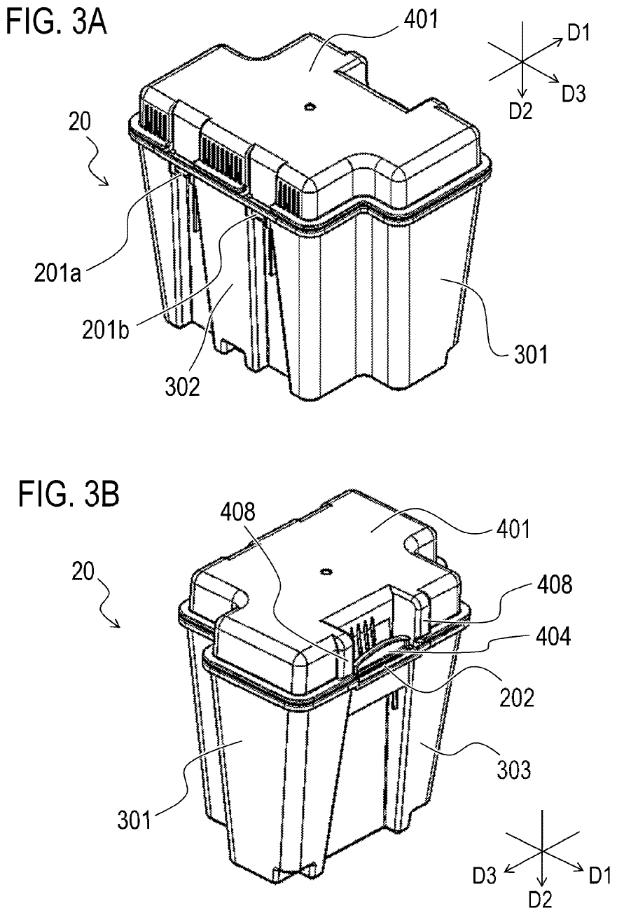

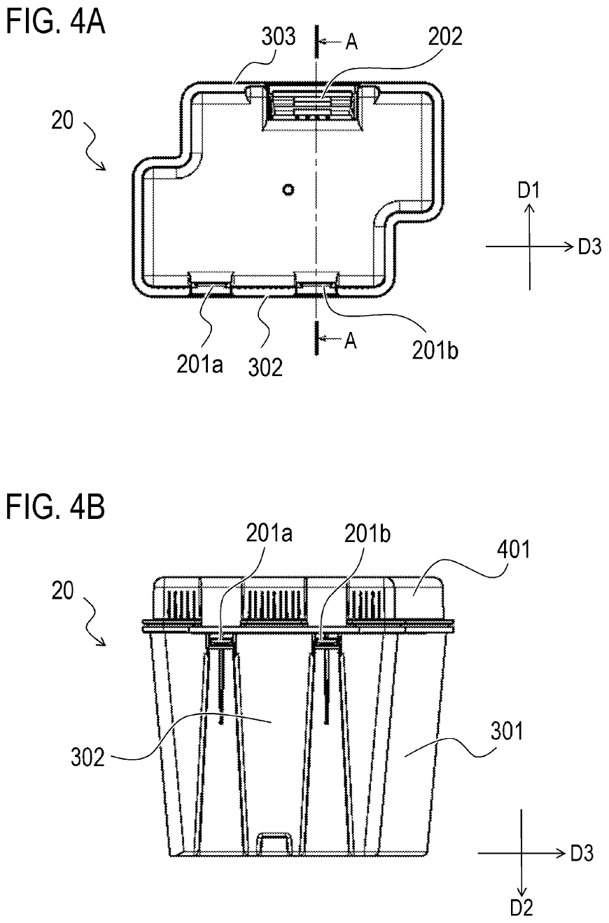

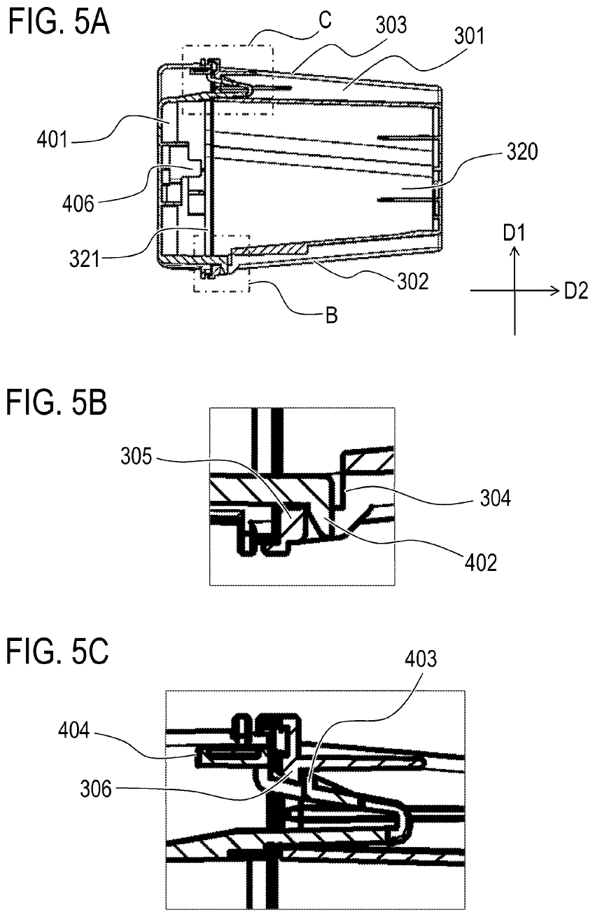

FIG. 3A and FIG. 3B are perspective views of a protective case 20 included in the liquid ejection head unit according to the present embodiment, of which FIG. 3A is a diagram illustrating a first sidewall side and FIG. 3B is a diagram illustrating a second sidewall side. FIG. 4A is a top view of the protective case 20, and FIG. 4B is a front view thereof. FIG. 5A is a cross-sectional view along a line A-A shown in FIG. 4A, FIG. 5B is an enlarged view of a portion B shown in FIG. 5A, and FIG. 5C is an enlarged view of a portion C shown in FIG. 5A.

The protective case 20 is configured to include a case member 301 serving as a case main body and a lid member 401 serving as a lid. The case member 301 has a containing portion 320 for containing the liquid ejection head 10 and an opening portion 321 for opening the containing portion 320 to the outside such that the liquid ejection head 10 is inserted into the containing portion 320 in the direction D2. The lid member 401 is configured to be attachable to and detachable from the case member 301 so as to close the opening portion 321.

The case member 301 has a first sidewall 302 and a second sidewall 303 which correspond to side surfaces thereof in the direction D1. The first sidewall 302 is a surface facing one side in the direction D1 (downstream side in a direction of an arrow), while the second sidewall 303 is a surface facing another side in the direction D1 (upstream side in the direction of the arrow). An upper portion of the first sidewall 302 is provided with two first engagement portions 201a and 201b for the case member 301 to be engaged with the lid member 401. An upper portion of the second sidewall 303 is provided with a second engagement portion 202 for the case member 301 to be engaged with the lid member 401.

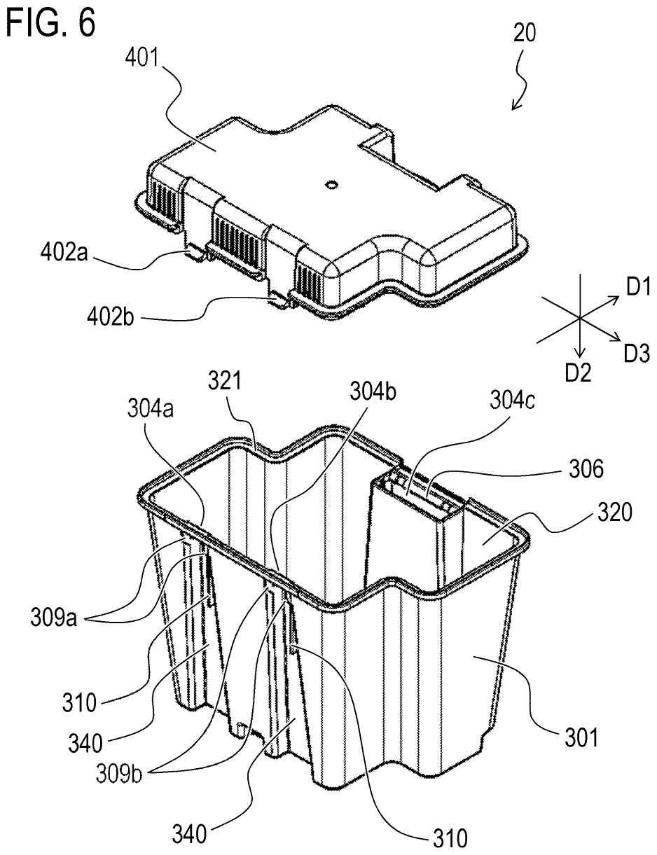

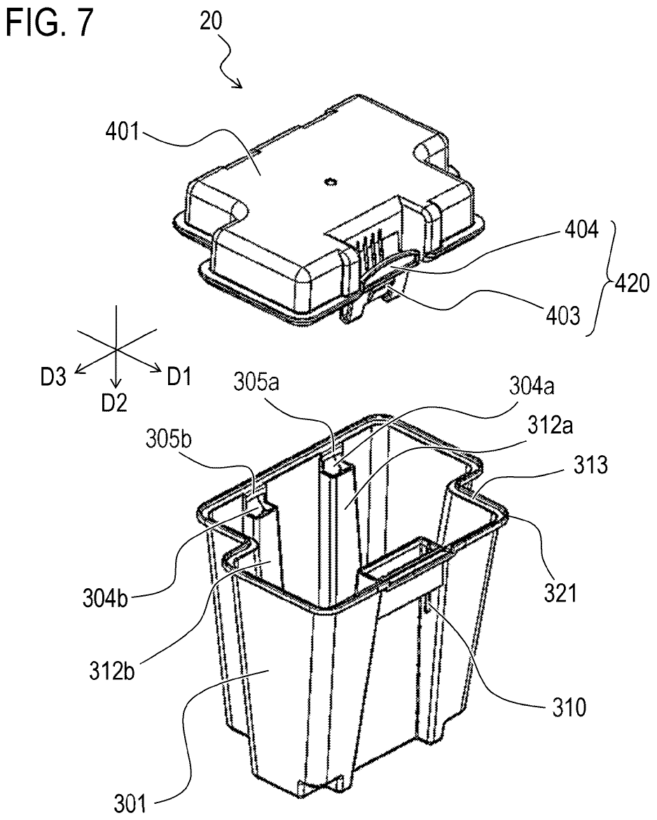

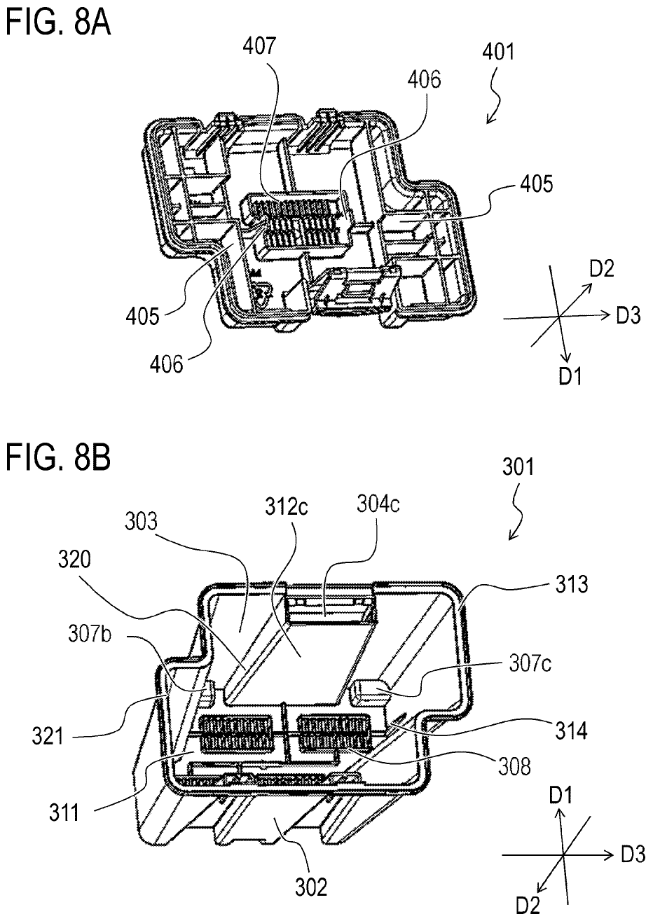

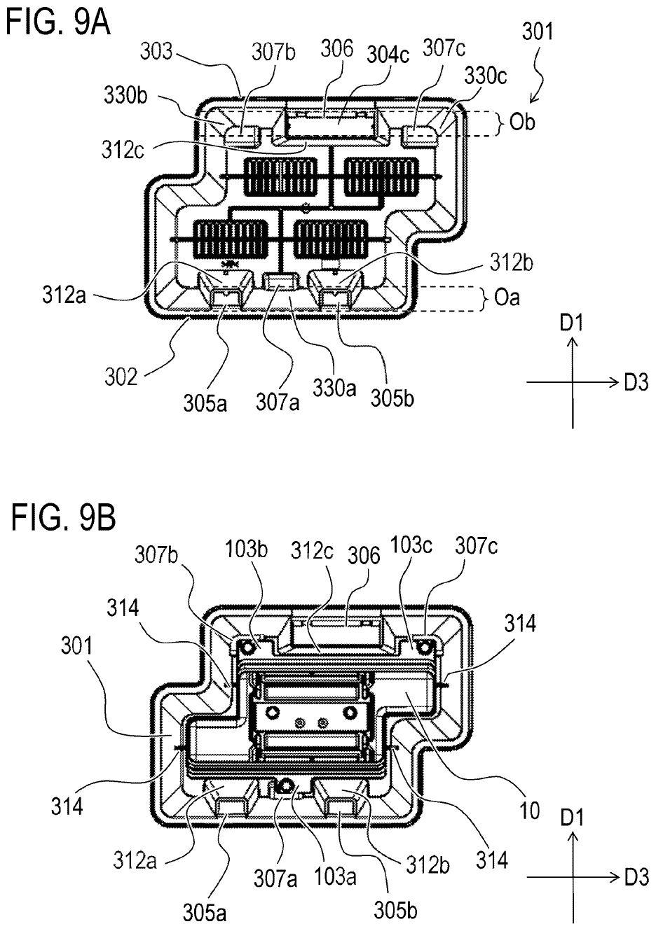

FIG. 6 and FIG. 7 are exploded perspective views of the protective case 20, which respectively illustrate the case member 301 and the lid member 401 from a first sidewall side and from a second sidewall side. Meanwhile, FIG. 8A is a perspective view of a bottom surface of the lid member 401, FIG. 8B is a perspective view of the case member 301 from a top surface thereof, and FIG. 9A is a top face view of the case member 301.

The case member 301 has an inner bottom surface 311 serving as a bottom surface of the containing portion 320 and having a shape imitating a contour of the face surface of the liquid ejection head 10. Of the inner bottom surface 311, portions corresponding to the individual recording element substrates 101a to 101d are provided with a liquid holding portion 308 and have shapes capable of holding the liquid dripping from the recording element substrates 101a to 101d. In addition, portions of the inner bottom surface 311 which correspond to the reference portions 103a to 103c of the liquid ejection head 10 are provided with respective receiving surfaces 307a, 307b, and 307c. Due to these receiving surfaces 307a to 307c, the liquid ejection head 10 inserted into the containing portion 320 is configured to be held in a state where the recording element substrates 101a to 101d are slightly floated from the liquid holding portion 308. The receiving surface 307a is formed of an inwardly projecting portion of the first sidewall 302, while each of the receiving surfaces 307b and 307c is formed of an inwardly projecting portion of the second sidewall 303.

The first sidewall 302 has projecting portions 312a and 312b on both sides of the receiving surface 307a in the direction D3. As shown in FIG. 7, the projecting portions 312a and 312b have upwardly rising portions of the case member 301 respectively formed with openings 304a and 304b (first and third openings). The openings 304a and 304b extend through the case member 301 at positions in the containing portion 320 which are inward of a top surface portion 313 of the case member 301 corresponding to an opening edge of the opening portion 321. The top surface portion 313 (opening edge portion of the opening portion 321) of the case member 301 forms first hooked portions 305a and 305b serving as engaged portions at positions (edge portions of the openings 304a and 304b in the case member 301) where the openings 304a and 304b are provided.

The second sidewall 303 has a projecting portion 312c between the receiving surface 307b and the receiving surface 307c. As shown in FIG. 8B, in the projecting portion 312c, an opening 304c (second opening portion) is formed at a position in the containing portion 320 which is inward of the top surface portion 313 of the case member 301. As shown in FIG. 9A, the top surface portion 313 (opening edge portion of the opening portion 321) forms a second hooked portion 306 serving as the engaged portion at a position (edge portion of the opening 304c in the case member 301) corresponding to one side of the opening 304c.

In the case member 301 thus configured, on each of the first sidewall 302 side and the second sidewall 303 side, the receiving surfaces 307a to 307c of the reference portions 103a to 103c and engagement portions configured to include the openings 304a to 304c and the hooked portions 305a, 305b, and 306 are alternately arranged in top view. A height of the case member 301 is set to such a level that an upper portion of the casing 105 of the liquid ejection head 10 is exposed to regulate movement of the casing 105 with a portion of the lid member 401 described later. As a material of the case member 301, a molding material of polypropylene is used in the present embodiment.

As shown in FIG. 6 and FIG. 7, the lid member 401 includes first hooking portions 402a and 402b at positions corresponding to the openings 304a and 304b of the case member 301, while including a second hooking portion 403 at a position corresponding to the opening 304c.

The first hooking portions 402a and 402b are fixed hooking portions. The first hooking portion 402a and the first hooking portion 402b are disposed to be arranged in the direction D3, while respectively serving as a first hooking portion forming a first engagement portion and a third hooking portion forming a third engagement portion. The first hooking portion 402a can be inserted through the opening 304a, and the first hooking portion 402a can be engaged with the first hooked portion 305a (edge portion of the opening 304a in the case member 301) by being inserted through the opening 304a. The first hooking portion 402b can be inserted through the opening 304b, and the first hooking portion 402b can be engaged with the first hooked portion 305b (edge portion of the opening 304b in the case member 301) by being inserted through the opening 304b.

The second hooking portion 403 is provided as a movable hooking portion. The movable second hooking portion 403 can be disengaged by pushing a handle portion 404 provided at an upper portion. In other words, a second engagement portion 420 including the second hooking portion 403 and the handle portion 404 is elastically deformed into a non-engaged posture in which the second hooking portion 403 is not engaged with the hooked portion 306 as a result of reception of an external force by the handle portion 404. When such an external force is removed, the second engagement portion including the second hooking portion 403 and the handle portion 404 restores to an engaged posture in which the second hooking portion 403 can form an engaged state with the hooked portion 306. The second hooking portion 403 can be inserted through the opening 304c, and the second hooking portion 403 can be engaged with the second hooked portion 306 (edge portion of the opening 304c in the case member 301) by being inserted through the opening 304c to result in removal of pressure exerted on the handle portion 404.

As shown in FIG. 8A, on a lower surface side of the lid member 401, a rib 405 for regulating movement of an outer shape of the casing 105 of the liquid ejection head 10 is provided. In addition, at positions corresponding to the flow path tubes provided at the top surface of the liquid ejection head 10, a liquid holding portion 407 is provided to be able to hold the liquid dripping from the flow path tubes. Furthermore, a portion of the rib forming an outer periphery of the liquid holding portion 407 protrudes to form a press-against portion 406, which is configured to press the elastic member 107 on the top surface of the liquid ejection head 10 contained in the protective case 20. The elastic member 107 is disposed between the case member 301 and the lid member 401 so as to be compressed in the direction D2. By pressing this elastic member 107, it is possible to regulate the movement of the liquid ejection head 10 contained in the protective case 20. As a material of the lid member 401, the molding material of polypropylene is also used in the present embodiment.

FIG. 9B is a top view (as seen in the direction D2) illustrating a state where the liquid ejection head 10 is contained in the case member 301. The opening portion 321 has an opening shape substantially corresponding to an outline shape of the liquid ejection head 10 when viewed in the direction D2. Since each projecting portion 312 formed on the case member 301 rises up to an upper portion of the case member 301, the projecting portion 312 serves as a guide when the liquid ejection head 10 is contained in the case member 301. In other words, due to the projecting portions 312a, 312b and 312c, recessed portions 330a, 330b and 330c having shapes recessed in the direction D1 correspondingly to outer shapes of the reference portions 103a to 103c when viewed in the direction D2 extend along a direction of insertion (direction D2) of the liquid ejection head 10 (see FIG. 9A). The recessed portions 330a, 330b, and 330c guide the reference portions 103a to 103c in the direction D2 when the liquid ejection head 10 is inserted into the containing portion 320 of the case member 301. Furthermore, a rib 314 is also provided at a lower portion of an inner surface of the containing portion 320 to serve as a guide for the insertion of the liquid ejection head 10. When the liquid ejection head 10 is contained along these guides, the positioning reference portions 103a, 103b and 103c of the liquid ejection head 10 are held on the receiving surfaces 307a, 307b and 307c of the case member 301.

As shown in FIG. 9A, when viewed in the direction D2, the recessed portion 330a serving as a first recessed portion is located between the first hooked portion 305a serving as a first engaged portion and the first hooked portion 305b serving as a third engaged portion in the direction D3 intersecting each of the direction D2 and the direction D1. The first hooked portion 305a serving as the first engaged portion and the recessed portion 330a serving as the first recessed portion have a region Oa where the first hooked portion 305a and the recessed portion 330a overlap each other when viewed in the direction D3. Likewise, the first hooked portion 305b serving as the third engaged portion and the recessed portion 330a serving as the first recessed portion have the region Oa where the first hooked portion 305b and the recessed portion 330a overlap each other when viewed in the direction D3.

As shown in FIG. 9A, when viewed in the direction D2, the second hooked portion 306 serving as a second engaged portion is located between the recessed portion 330b serving as a second recessed portion and the recessed portion 330c serving as a third recessed portion in the direction D3. The second hooked portion 306 serving as the second engaged portion and the recessed portion 330b serving as the second recessed portion have a region Ob where the second hooked portion 306 and the recessed portion 330b overlap each other when viewed in the direction D3. Likewise, the second hooked portion 306 serving as the second engaged portion and the recessed portion 330c serving as the third recessed portion have the region Ob where the second hooked portion 306 and the recessed portion 330c overlap each other when viewed in the direction D3.

As shown in FIG. 9B, when viewed in the direction D2, the reference portion 103a serving as a first reference portion, the first hooked portion 305a serving as the first engaged portion, and the first hooked portion 305b serving as the third engaged portion are disposed to be substantially arranged in the direction D3. Meanwhile, when viewed in the direction D2, the reference portion 103b serving as a second reference portion, the reference portion 103c serving as a third reference portion, and the second hooked portion 306 serving as the second engaged portion are disposed to be substantially arranged in the direction D3.

Thus, since the case member 301 is structured to form the engagement portions by using spaces beside the positioning reference portions 103a to 103c projecting from the sidewalls of the liquid ejection head 10 to an outer periphery, it is possible to reduce a size of the protective case 20.

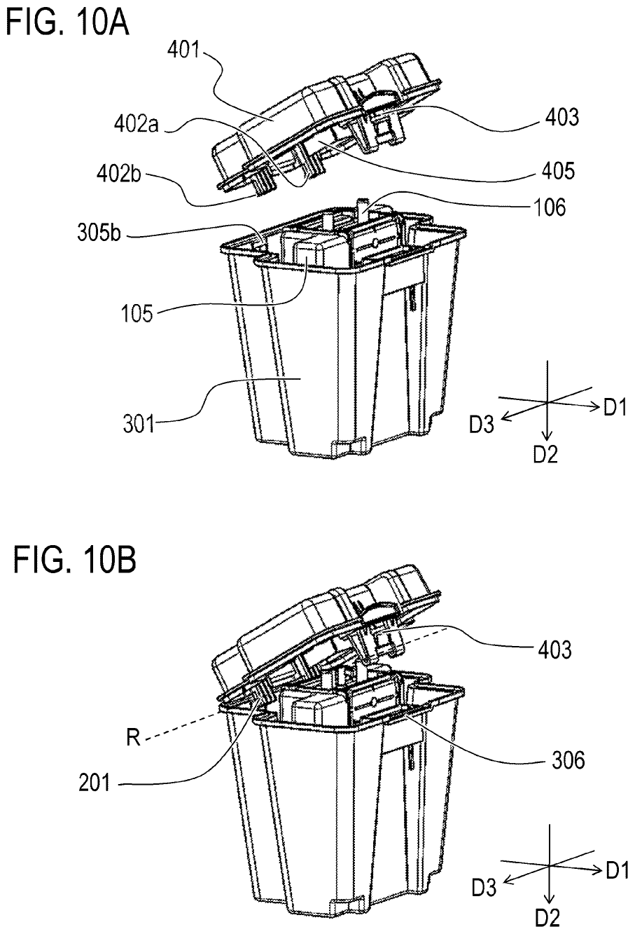

FIG. 10A and FIG. 10B are diagrams illustrating attachment of the lid member 401, of which FIG. 10A is a view before engagement and FIG. 10B is a view during the engagement. The liquid ejection head 10 contained in the case member 301 is in a state where the casing 105 and the flow path tubes 106 in the upper portion thereof protrude from the case member 301 and, through complete engagement of the lid member 401, movement thereof is regulated with the rib 405 and the press-against portion 406, with the result that the liquid ejection head 10 is held. The lid member 401 lowers the first hooking portions 402a and 402b toward the first hooked portions 305a and 305b of the case member 301, rotates the lid member 401 around top surface edge portions in the vicinity of the two first engagement portions 201a and 201b that have started to engage, and engages the second hooking portion 403 with the second hooked portion 306 on the opposite side. In other words, starting from a contact portion between a region of the edge portion of the opening portion 321 in the case member 301 which extends in the direction D3 in the vicinity of the first hooked portions 305a and 305b and the lid member 401, the case member 301 and the lid member 401 are rotated. This rotation is around a rotation axis along the direction D3 passing through the contact portion mentioned above. Such rotation allows the case member 301 and the lid member 401 to assume a closed state where the opening portion 321 is closed and an open state where the opening portion 321 is open to the outside. By causing the rotation while engaging the two first engagement portions 201a and 201b, it is possible to stably rotate the lid member 401 even in the protective case 20 in which the first sidewall 302 and the second sidewall 303 are offset from each other in the first direction as in the present embodiment.

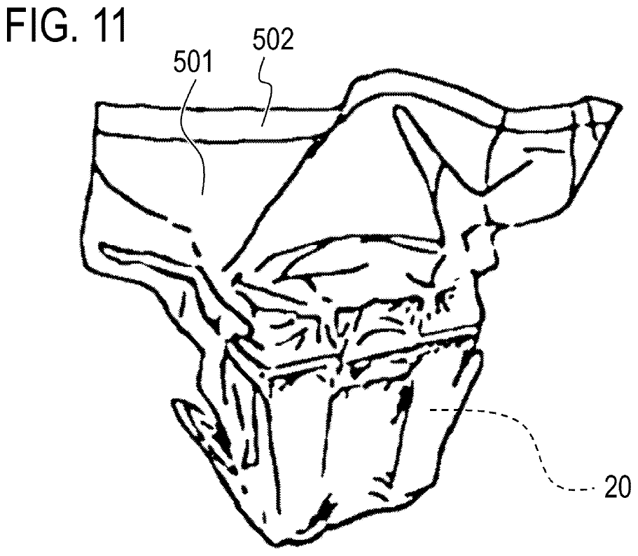

FIG. 11 is a perspective view illustrating a state where the protective case 20 is contained in a bag member 501. In the present embodiment, as the bag member 501, a three-side sealed bag formed of a laminate film or the like is used and, after the protective case 20 is contained therein, a pressure inside the bag member 501 is reduced, and an opening is heat-welded to seal the bag member 501. An inner space of the bag member 501 is reduced by the pressure reduction, and the bag member 501 closely adheres to the protective case 20.

As shown in FIG. 6, in the present embodiment, the case member 301 has protruding portions 309a and 309b (first protruding portions) provided around the first engagement portions 201a and 201b to project outward from the first engagement portions 201a and 201b. In addition, as shown in FIG. 3B, the lid member 401 has a protruding portion 408 (second protruding portion) on both sides of the handle portion 404 of the second engagement portion 202 in the direction D3 to project outward from the handle portion 404 in the direction D1. These protruding portions 309a, 309b and 408 prevent the bag member 501 from pushing the engagement portions in a direction of disengagement even in a state where the pressure in the bag member 501 is reduced.

In addition, since there is a recessed portion outside each projecting portion 312 of the case member 301, a vertical rib 310 for allowing a plurality of the case members 301 to be easily stacked on each other when only the case members 301 are distributed can be formed without jutting outward. In a region of an outer surface of the case member 301 which is adjacent to the recessed portion 330a in the containing portion 320 in the direction D3, an outer surface recessed portion 340 is formed to be recessed in the direction D1. The vertical rib 310 formed in the outer surface recessed portion 340 has no risk of damaging the bag member 501 even when the pressure in the bag member 501 is reduced during distribution of the liquid ejection head 10. The vertical rib 310 is provided to fit inside an outermost periphery of the case member 301 when viewed in the direction D2. Therefore, the case member 301 reduced in size can improve distribution efficiency.

In the protective case 20 of the liquid ejection head 10 thus configured, a space beside the receiving surface of each of the positioning reference portions of the liquid ejection head 10 can effectively be used as the space for engaging the lid member 401, and therefore it is possible to provide the protective case which is reduced in size, while protecting the top face of the liquid ejection head 10.

### Second Embodiment

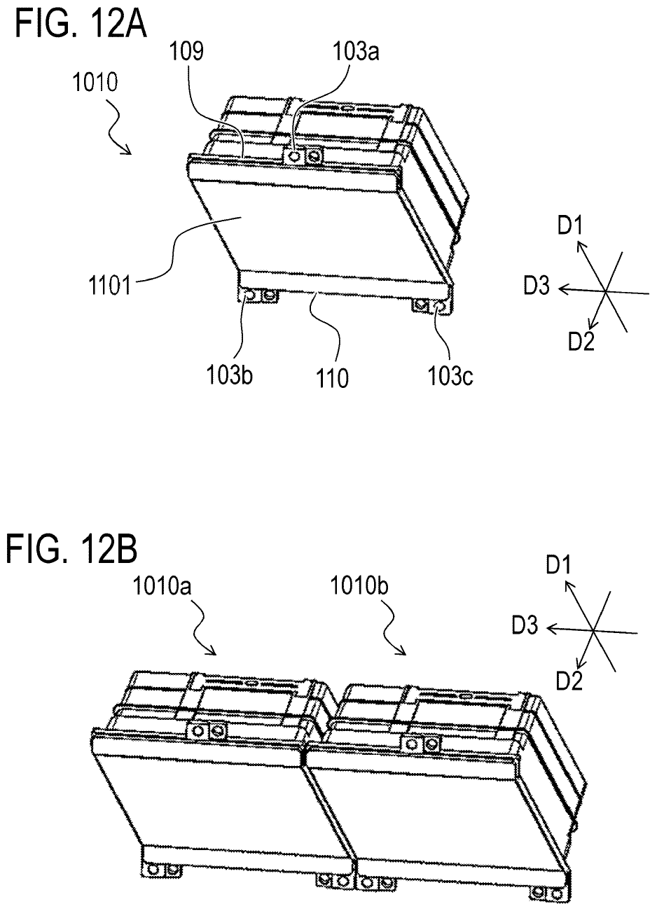

Referring to FIG. 12A to FIG. 14B, a description will be given of a liquid ejection head unit according to a second embodiment of the present disclosure. In the second embodiment, the same reference signs will be assigned herein to components used in common with the first embodiment and, in the second embodiment, only points different from those in the first embodiment will be described. Matters not particularly described in the second embodiment are the same as in the first embodiment.

FIG. 12A is a perspective view of a liquid ejection head 1010 included in the liquid ejection head unit according to the second embodiment of the present disclosure, and FIG. 12B is a perspective view illustrating an example of use of the liquid ejection head 1010.

As shown in FIG. 12A, in the liquid ejection head 1010 used in the second embodiment, a recording element substrate 1101 for ejecting liquid has a parallelogram shape. In addition, as shown in FIG. 12B, the liquid ejection head also allows a page-wide-type liquid ejection head to be configured by arranging a plurality of liquid ejection heads 1010a and 1010b in a longitudinal direction (direction D3). Therefore, the reference portions 103a, 103b and 103c of the liquid ejection head 1010 are formed on two opposing sidewalls which do not disturb proximity of the liquid ejection heads 1010a and 1010b to each other in the same manner as in the first embodiment. At a center portion of the first sidewall 109, the positioning reference portion 103a is formed and, on both ends of the opposing second sidewall 110, the reference portion 103b and 103c are formed. In the present embodiment also, the first sidewall 109 and the second sidewall 110 are offset from each other in the direction D3.

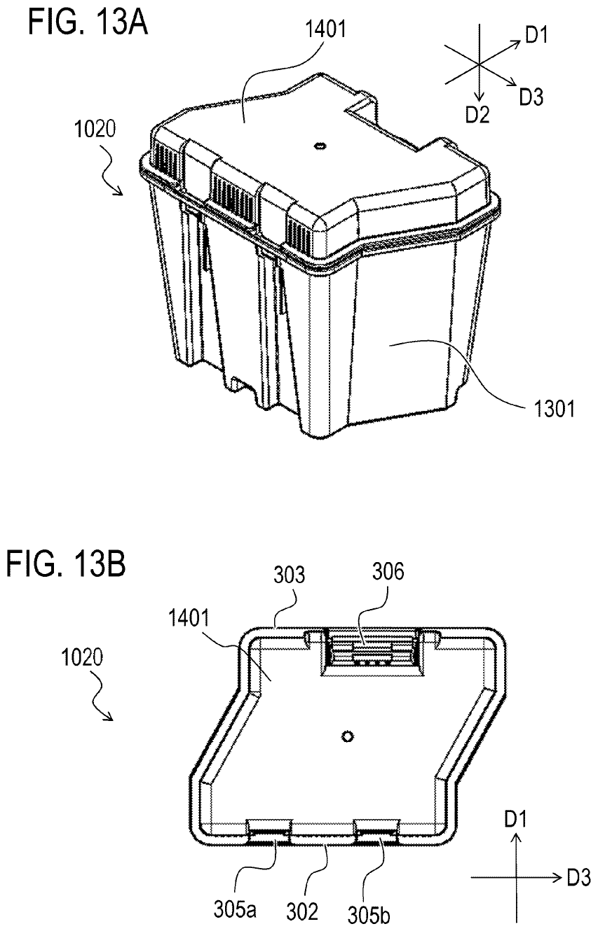

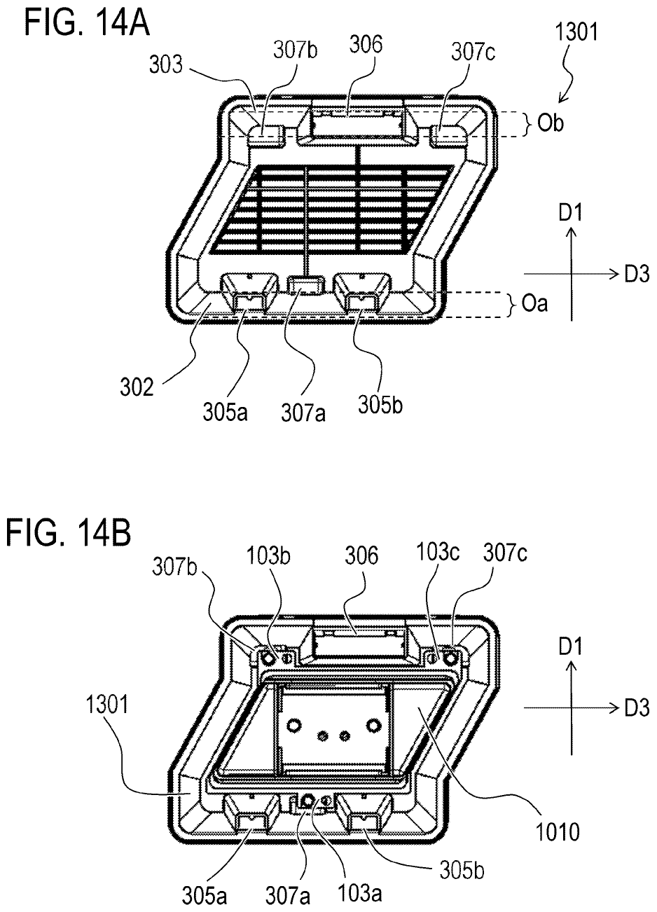

FIG. 13A and FIG. 13B are diagrams illustrating a protective case 1020 in the second embodiment of the present disclosure, of which FIG. 13A is a perspective view and FIG. 13B is a top view. FIG. 14A is a top view of a case member 1301, and FIG. 14B is a diagram illustrating a state where the liquid ejection head 1010 is contained in the case member 1301.

Thus, even when an outer shape of the recording element substrate 1101 is a parallelogram or a face surface configured to include a plurality of the recording element substrates 1101 has a parallelogram shape, the reference portions 103a, 103b, and 103c are configured in the same manner as in the first embodiment. That is, at a center portion of a first sidewall 1109, the first reference portion 103a is formed and, on an opposing second sidewall 1110, the two second reference portions 103b and 103c are formed. With such a configuration, in the same manner as in the first embodiment, a space beside a receiving surface of each of the reference portions of the liquid ejection head 1010 can effectively be used as a space for engaging a lid member 1401. Therefore, it is possible to provide the protective case 1020 which is reduced in size, while protecting a top surface of the liquid ejection head 1010.

### Third Embodiment

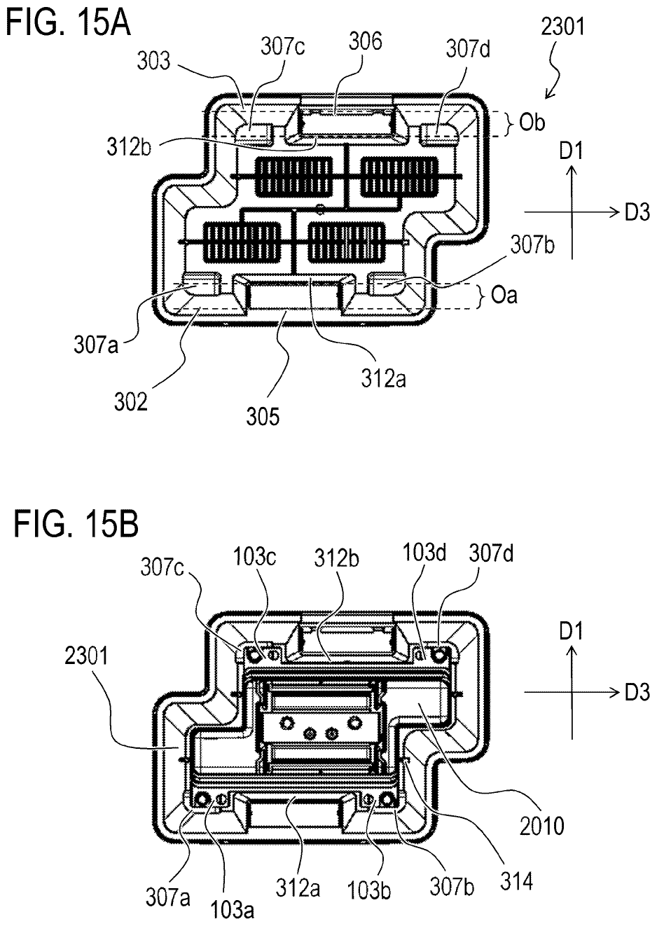

Referring to FIG. 15A and FIG. 15B, a description will be given of a liquid ejection head unit according to a third embodiment of the present disclosure. In the third embodiment, the same reference signs will be assigned herein to components used in common with the first and second embodiments and, in the third embodiment, only points different from those in the first and second embodiments will be described. Matters not particularly described in the third embodiment are the same as those in the first and second embodiments.

FIG. 15A is a top view of a case member illustrating the third embodiment of the present disclosure, and FIG. 15B is a top view illustrating a state where a liquid ejection head is contained in the case member.

As shown in FIG. 15B, a liquid ejection head 2010 used in the third embodiment has the two positioning reference portions 103a and 103b on both ends of the first sidewall, while also having the two positioning reference portions 103c and 103d on the opposing second sidewall. In a case of the liquid ejection head 2010, as shown in FIG. 15A, the receiving surfaces 307a and 307b are formed on both end portions of the first sidewall 302, and the projecting portion 312a is formed at a center portion thereof to form the first hooked portion 305. Likewise, the receiving surface 307c and a receiving surface 307d are formed on both end portions of the opposing second sidewall 303, and the projecting portion 312b is formed at a center portion thereof to form the second hooked portion 306.

The lid member may be formed with a first hooking portion and a second hooking portion in accordance with the case member 301 in the same manner as in the first embodiment to be able to form a protective case.

Although the direction D1, the direction D2, and the direction D3 are assumed to be three directions that are perpendicular to each other in the present embodiment, the direction D1, the direction D2, and the direction D3 may also be directions that intersect each other at angles slightly larger than a right angle.

With regard to the plurality of recording element substrates included in the liquid ejection surface of the liquid ejection head 10, the present embodiment has given an example in which the liquid ejection surface is configured to include the four recording element substrates, but the liquid ejection surface may also be configured to include five or more recording element substrates.

With regard to the plurality of reference portions used when the liquid ejection head 10 is attached to the liquid ejection apparatus, the present invention has given an example in which the one liquid ejection head 10 includes the three reference portions or the four reference portions, but a configuration in which the one liquid ejection head 10 includes five or more reference portions may also be adopted.

In the present embodiment, with regard to a configuration of each of the engagement portions between the case member 301 and the lid member 401, the lid member 401 serving as one member is provided with the hooking portion, while the case member 301 serving as another member is provided with the hooked portion, but the engagement portion is not limited to such a configuration. In other words, it may also be possible to adopt a configuration in which the case member 301 is provided with the hooking portion, while the lid member 401 is provided the hooked portion. Furthermore, the configuration of the engagement portion is also not limited to the configuration including the hooking portion and the hooked portion, and various known engaging configuration can be adopted.

In the individual embodiments described above, the respective configurations can be combined with each other.

According to the present disclosure, it is possible to reduce a size of a liquid ejection head unit as a form of protection of a liquid ejection head by a protective case.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-189808, filed on Oct. 29, 2024, which is hereby incorporated by reference herein in its entirety.

What is claimed is:

1. A liquid ejection head unit comprising:
a liquid ejection head attachable to and detachable from a liquid ejection apparatus; and
a protective case capable of containing the liquid ejection head detached from the liquid ejection apparatus,
wherein the liquid ejection head has a reference portion protruding in a first direction from a first end surface facing one side in the first direction, the reference portion being used in a case where the liquid ejection head is attached to the liquid ejection apparatus,
wherein the protective case includes:
a case main body having a containing portion that contains the liquid ejection head, an opening portion that opens the containing portion to outside such that the liquid ejection head is inserted into the containing portion in a second direction intersecting the first direction, and an engaged portion; and
a lid having an engagement portion capable of being engaged with the engaged portion and attachable to and detachable from the case main body so as to close the opening portion,
wherein the containing portion has a recessed portion recessed in the first direction, and the recessed portion extends in the second direction so as to guide the reference portion in the second direction in a case where the liquid ejection head is inserted into the containing portion, and
wherein the engaged portion and the recessed portion have a region where the engaged portion and the recessed portion overlap each other in a case of being viewed in a third direction intersecting each of the first direction and the second direction.

2. The liquid ejection head unit according to claim 1,
wherein the recessed portion has a shape recessed correspondingly to an outer shape of the reference portion in a case of being viewed in the second direction.

3. The liquid ejection head unit according to claim 1,
wherein, with the reference portion being a first reference portion, the engaged portion being a first engaged portion, the engagement portion being a first engagement portion, and the recessed portion being a first recessed portion,
the liquid ejection head has a second reference portion protruding in the first direction from a second end surface facing another side in the first direction to be used in a case where the liquid ejection head is attached to the liquid ejection apparatus,
wherein the case main body has a second engaged portion,
wherein the lid has a second engagement portion capable of being engaged with the second engaged portion,
wherein the containing portion has a second recessed portion recessed in the first direction, and the second recessed portion extends in the second direction so as to guide the second reference portion in the second direction in a case where the liquid ejection head is inserted into the containing portion, and
wherein the second engaged portion and the second recessed portion have a region where the second engaged portion and the second recessed portion overlap each other in a case of being viewed in the third direction.

4. The liquid ejection head unit according to claim 3,
wherein the liquid ejection head has a third reference portion protruding in the first direction from a position on the second end surface different from that of the second reference portion to be used in a case where the liquid ejection head is attached to the liquid ejection apparatus,
wherein the containing portion has a third recessed portion recessed in the first direction, and the third recessed portion extends in the second direction so as to guide the third reference portion in the second direction in a case where the liquid ejection head is inserted into the containing portion, and
wherein the second engaged portion and the third recessed portion have a region where the second engaged portion and the third recessed portion overlap each other in a case of being viewed in the third direction.

5. The liquid ejection head unit according to claim 4,
wherein, in a case of being viewed in the second direction, the second engaged portion is located between the second recessed portion and the third recessed portion in the third direction.

6. The liquid ejection head unit according to claim 4,
wherein the case main body has a third engaged portion,
wherein the lid has a third engagement portion capable of being engaged with the third engaged portion, and
wherein the third engaged portion and the first recessed portion have a region where the third engaged portion and the first recessed portion overlap each other in a case of being viewed in the third direction.

7. The liquid ejection head unit according to claim 6,
wherein, in a case of being viewed in the second direction, the first recessed portion is located between the first engaged portion and the third engaged portion in the third direction.

8. The liquid ejection head unit according to claim 3,
wherein the second recessed portion has a shape recessed correspondingly to an outer shape of the second reference portion in a case of being viewed in the second direction.

9. The liquid ejection head unit according to claim 4,
wherein the third recessed portion has a shape recessed correspondingly to an outer shape of the third reference portion in a case of being viewed in the second direction.

10. The liquid ejection head unit according to claim 6,
wherein the first engagement portion has a first hooking portion,
wherein the first engaged portion has a first opening extending through the case main body at a position inward of the opening portion in the containing portion, and the first hooking portion can be inserted through the first opening,
wherein the first hooking portion and an edge portion of the first opening in the case main body are engaged with each other to bring the first engagement portion and the first engaged portion into an engaged state,
wherein the third engagement portion has a third hooking portion,
wherein the third engaged portion has a third opening extending through the case main body at a position inward of the opening portion in the containing portion, and the third hooking portion can be inserted through the third opening, and
wherein the third hooking portion and an edge portion of the third opening in the case main body are engaged with each other to bring the third engagement portion and the third engaged portion into the engaged state.

11. The liquid ejection head unit according to claim 10,
wherein, by rotating the case main body and the lid around a rotation axis along the third direction, the case main body and the lid are allowed to assume a closed state where the opening portion is closed and an open state where the opening portion is open to the outside, and the rotation axis passes through a contact portion between a region of an edge portion of the opening portion in the case main body, which extends in the third direction in the vicinity of each of the first engaged portion and the third engaged portion, and the lid.

12. The liquid ejection head unit according to claim 11,
wherein at least one of the second engagement portion and the second engaged portion has a second hooking portion capable of being engaged with another thereof, and
wherein at least one of the second engagement portion and the second engaged portion is configured to be elastically deformed, as a result of receiving an external force, into a non-engaged posture in which the second hooking portion is not engaged with the other of the second engagement portion and the second engaged portion, and to be restored, as a result of removal of the external force, to an engaged posture in which the second hooking portion can form an engaged state with the other of the second engagement portion and the second engaged portion.

13. The liquid ejection head unit according to claim 1,
further comprising: an elastic member that is compressed in the second direction between the lid and the liquid ejection head.

14. The liquid ejection head unit according to claim 1,
wherein the case main body has, at a position adjacent to the engaged portion in the third direction, a first protruding portion protruding outward from the engaged portion in the first direction, and
wherein the lid has, at a position adjacent to the engagement portion in the third direction, a second protruding portion protruding outward from the engagement portion in the first direction.

15. The liquid ejection head unit according to claim 1,
wherein the liquid ejection head has a liquid ejection surface, and is contained in the containing portion such that the liquid ejection surface faces a bottom surface of the containing portion, and
wherein the reference portion is provided at a position adjacent to the liquid ejection surface.

16. The liquid ejection head unit according to claim 15,
wherein the liquid ejection surface is configured to include a plurality of recording element substrates arranged adjacent to each other,
wherein the plurality of recording element substrates include:
a first substrate row aligned in the third direction; and
a second substrate row adjacent to the first substrate row in the first direction and aligned in the third direction, and
wherein the plurality of recording element substrates included in the first substrate row and the plurality of recording element substrates included in the second substrate row are offset from each other in the third direction.

17. The liquid ejection head unit according to claim 1,
wherein the case main body has, in a region of an outer surface thereof which is adjacent to the recessed portion in the third direction, an outer surface recessed portion recessed in the first direction and a rib provided in the outer surface recessed portion, and
wherein the rib is provided so as to fit inside an outermost periphery of the case main body in a case of being viewed in the second direction.

18. A protective case capable of containing a liquid ejection head detached from a liquid ejection apparatus, the protective case comprising:
a case main body; and a lid attachable to and detachable from the case body,
wherein the case main body includes:
a containing portion that contains the liquid ejection head, the liquid ejection head having a reference portion protruding in a first direction to be used in a case where the liquid ejection head is attached to the liquid ejection apparatus;
an opening portion that opens the containing portion to outside such that the liquid ejection head is inserted into the containing portion in a second direction intersecting the first direction; and
an engaged portion,
wherein the lid has an engagement portion capable of being engaged with the engaged portion,
wherein the containing portion has a recessed portion recessed in the first direction, and the recessed portion extends in the second direction so as to guide the reference portion in the second direction in a case where the liquid ejection head is inserted into the containing portion, and
wherein the engaged portion and the recessed portion have a region where the engaged portion and the recessed portion overlap each other in a case of being viewed in a third direction intersecting each of the first direction and the second direction.
